(19) United States
(12) Patent Application Publication
(10) Pub. No.: US 2007/0202035 A1
(43) Pub. Date: Aug. 30, 2007

(54) Fluidized Bed Method And Reactor For Carrying Out Exotermic Chemical Equilibruim Reaction

(76) Inventors: Christian Walsdorff, Ludwigshafen (DE); Lothar Seidemann, Mannheim (DE); Martin Sesing, Waldsee (DE); Martin Fiene, Niederkirchen (DE); Thomas Grassler, Limburgerhof (DE); Olga Schubert, Ludwigshafen (DE); Eckhard Stroefer, Mannheim (DE); Martin Sohn, Mannheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/594,243

(22) PCT Filed: Mar. 21, 2005
(86) PCT No.: PCT/EP05/02973

§ 371 Date: Sep. 25, 2006

(30) Foreign Application Priority Data
Mar. 25, 2004 (DE) 102004014677.2

(51) Int. Cl. F27B 15/00

(52) U.S. Cl. 423/507; 422/139

(57) ABSTRACT

The invention relates to a process for carrying out exothermic chemical equilibrium reactions in a fluidized-bed reactor, wherein there is a temperature distribution in the fluidized bed of the fluidized-bed reactor and the temperature difference between the lowest temperature and the highest temperature is at least 10 K. The invention further relates to a fluidized-bed reactor for carrying out chemical reactions in a fluidized bed (5), wherein at least one heat exchanger (12, 28) is located in the fluidized bed (5) to control the temperature distribution.

The invention relates to a process for carrying out exothermic chemical equilibrium reactions in a fluidized-bed reactor. The invention further relates to a fluidized-bed reactor for carrying out the process.

An example of an exothermic chemical equilibrium reaction is the process for the catalytic oxidation of hydrogen chloride by means of oxygen to give chlorine developed in 1868 by Deacon.

The conversion of hydrogen chloride into chlorine enables chlorine production to be decoupled from sodium hydroxide production by chloralkali electrolysis. Such decoupling is attractive since the worldwide demand for chlorine is growing more strongly than the demand for sodium hydroxide. In addition, hydrogen chloride is obtained in large quantities as coproduct, for example in phosgenation reactions, for instance in the preparation of isocyanates. The hydrogen chloride formed in the preparation of isocyanates is predominantly used in the oxychlorination of ethylene to 1,2-dichloroethane, which is processed further to vinyl chloride and finally to PVC. The Deacon process thus also makes it possible to decouple isocyanate production and vinyl chloride production.

In the Deacon reaction, the position of the equilibrium becomes less favorable in terms of the desired end product as the temperature increases. It is therefore advantageous to use catalysts which have a very high activity and allow the reaction to proceed at a lower temperature.

Catalysts suitable for carrying out the Deacon reaction are, for example, ruthenium compounds on support materials, as are described in GB 1,046,313, DE-A 197 48 299 or DE-A 197 34 412.

Further suitable catalysts are catalysts based on chromium oxide, as are known, for example, from U.S. Pat. No. 4,828,815.

The use of a fluidized-bed reactor for carrying out the Deacon reaction using supported copper compounds as catalysts is described in J. T. Quant et al., The Shell Chlorine Process which appeared in The Chemical Engineer, July/August 1963, pages CE 224 to CE 232.

S. Furusaki, Catalytic Oxidation of Hydrogen Chloride in a Fluid Bed Reactor, Al-ChE Journal, Vol. 19, No. 5, 1973, pages 1009 to 1016, likewise describes the use of a fluidized-bed reactor for carrying out the Deacon reaction. The catalyst used here is a mixture of CuCl₂, KCl and SnCl₂.

Fluidized-bed processes are usually employed in order to achieve an essentially isothermal temperature distribution and, in particular, to avoid hot spots, i.e. regions of local overheating, as often occur in fixed-bed processes (cf., for example, Daizo Kunii and Octave Levenspiel, Fluidization Engineering, 2nd edition, 1991, page 313). This applies particularly to exothermic reactions such as the heterogeneously catalyzed gas-phase oxidation of hydrogen chloride to chlorine.

However, it has been found that it is not always advantageous to carry out such a reaction isothermally. Thus, for example, the chlorine yield in the Deacon process can be increased when the reaction is initially carried out at relatively high temperatures and the temperature is reduced as soon as the conversion approaches the equilibrium conversion.

It is an object of the invention to provide an improved process for carrying out exothermic chemical equilibrium reactions in a fluidized-bed reactor. In particular, it is an object of the invention to provide a process which gives an improved space-time yield, i.e. a greater yield in the same reactor volume and same reaction time as in the case of the processes known from the prior art.

It is likewise an object of the invention to provide a fluidized-bed reactor in which the process is carried out.

This object is achieved by a process for carrying out exothermic chemical equilibrium reactions in a fluidized-bed reactor, wherein there is a temperature distribution along the flow direction in the fluidized bed of the fluidized-bed reactor and the temperature difference between the lowest temperature and the highest temperature is at least 10 K.

In the present context, the flow direction is the direction in which the gas flows within the fluidized bed from a gas distributor located beneath the fluidized bed to the surface of the fluidized bed. The gas distributor can, for example, be a perforated plate or a plate having gas distributor nozzles distributed over it.

Fluidized-bed reactors generally have a cylindrical or approximately rotationally symmetric geometry and flow through them generally occurs parallel to the axis of rotation. In this sense, the flow direction formulated above can also be referred to as axial flow and is distinct from radial flows which occur locally within the fluidized bed but largely cancel one another out over the total height of the fluidized bed.

The temperature distribution within the fluidized bed in the process of the invention is preferably such that the temperature decreases from an absolute temperature maximum (i.e. the maximum temperature in the total fluidized bed) along the flow direction to the surface of the fluidized bed. For the present purposes, the surface is the area of the fluidized bed through which the gas flows out from the fluidized bed.

An advantage of such a temperature distribution corresponding to the process of the invention is improved space-time yields. Lower starting temperatures are necessary to achieve a very high thermodynamic equilibrium conversion, while higher temperatures within the fluidized bed are advantageous for kinetic reasons.

A further advantage of the temperature decreasing to the surface of the fluidized bed is that catalyst systems containing active components which are volatile at elevated temperature can be operated with better long-term stability. Such catalysts are, for example, supported ruthenium compounds. As a result of the temperature decreasing to the surface of the fluidized bed, volatile catalyst compounds can be captured again by colder catalyst particles in the upper region of the fluidized bed and can be conveyed continuously together with these back down to lower regions of the fluidized bed.

The difference between the temperature maximum within the fluidized bed and the lowest temperature prevailing in the process of the invention at a position above the temperature maximum, i.e. in the vicinity of the surface of the fluidized bed, is not more than 150° C., preferably not more than 100° C. and particularly preferably not more than 50° C.

In a particularly preferred process variant, the temperature decreases along the flow direction from an absolute temperature maximum both to the gas distributor and also to the surface of the fluidized bed. In a very particularly preferred process variant, the distance from the absolute temperature maximum to the gas distributor is smaller than the distance from the absolute temperature maximum to the surface of the fluidized bed.

The temperature of the reaction gases when they are introduced via the gas distributor into the fluidized bed is preferably below the lowest temperature occurring in the fluidized bed. In the case of an exothermic reaction, this leads to the temperature in the fluidized bed initially increasing in the flow direction until the absolute temperature maximum is reached. In the process of the invention, this allows heat exchanger capacities and thus capital costs to be reduced, since, firstly, a smaller quantity of heat has to be transferred to the feed gases and, secondly, the quantity of heat to be removed from the fluidized bed by means of heat exchangers installed in the fluidized bed is smaller, since the colder feed gas can take up a major part of the heat liberated in the exothermic reaction directly in the fluidized bed.

The temperature distribution in the fluidized bed is preferably controlled by heat transfer to at least one heat exchanger within the hot bed. When only one heat exchanger is used, this is preferably located in only part of the fluidized bed. Thus, in a preferred embodiment, there is no heat exchanger in the lower part of the fluidized bed, so that no heat of reaction is removed there. This results in a higher temperature after a temperature rise due to the exothermic reaction. A heat exchanger by means of which heat of reaction is removed is then located in the upper part of the fluidized bed. This enables a lower temperature to be set in the upper part of the fluidized bed.

In one embodiment, the fluidized bed is divided into two temperature zones. Positioning a plurality of heat exchangers in the fluidized bed or positioning a heat exchanger in the middle of the fluidized bed enables more than two temperature zones to be set.

In a particularly preferred embodiment of the fluidized-bed reactor, the distance between the gas distributor plate and the nearest heat exchanger above the gas distributor is at least 25 cm, in particular at least 50 cm. The optimum distance between gas distributor and heat exchanger is dependent on the gas throughput, the temperature of the feed gases, bubble formation characteristics and reaction kinetics as a function of the catalysts used. A distance of at least 25 cm is typically necessary to achieve an appropriately rising temperature between the gas distributor plate and the heat exchanger. However, conversely, an excessively great temperature increase and, associated therewith, an excessively large difference between the absolute temperature maximum and the lowest temperature at a position above the temperature maximum is also to be avoided. In general, the distance between the gas distributor plate and the heat exchanger should therefore be not more than 10 m, preferably not more than 6 m and in particular not more than 3 m. In a very particularly preferred embodiment of the invention, this distance is not more than 2 m.

The fluidized-bed reactor is preferably designed as a turbulent fluidized bed having a superficial gas velocity of from 1 to 5 m/s, as a highly expanded fluidized bed having a superficial gas velocity of from 0.5 to 2 m/s or as a bubble-forming fluidized bed having a superficial gas velocity of from 0.01 m/s to 1 m/s. The fluidized-bed reactor is particularly preferably designed as a bubble-forming fluidized bed having a superficial gas velocity of from 0.05 to 0.50 m/s, since particularly favorable heat transfer and particularly favorable mass transfer can be achieved at this superficial gas velocity. The superficial gas velocity is the gas volume flow under operating conditions divided by the free cross-sectional area of the reactor.

The use of two heat exchangers is also conceivable. In this case, one heat exchanger is located in the lower part of the fluidized bed and one heat exchanger is located in the upper part of the fluidized bed. Different quantities of heat are taken up or given off by the heat exchangers.

In a further embodiment, the temperature distribution can also be achieved by positioning one or more dividing plates between, in each case, two temperature zones. For the present purposes, a temperature zone is a region of approximately constant temperature in the fluidized bed. Suitable dividing plates are, for example, perforated plates or screen plates. Mixing of the fluidized bed is impaired at the position of the dividing plate, so that a smaller amount of fluidized granular material is entrained with the rising gas bubbles at the position of the dividing plate and at the same time a smaller amount of fluidized granular material flows counter to the flow direction of the gas bubbles through the dividing plate into the region of the fluidized bed above the dividing plate. This impairs convective heat transport, so that a distinct temperature boundary is established in the region of the dividing plate. A further improved separation of the temperature zone in the fluidized bed can be achieved by using a dividing plate having an insulating action.

In a further embodiment, a heat exchanger is located in at least one temperature zone in the fluidized-bed reactor of the invention to divide the fluidized bed into at least two temperature zones.

In a further embodiment of the fluidized-bed reactor, two temperature zones are each divided by a dividing plate. The dividing plate is preferably configured as a screen plate or as a perforated plate.

If divided plates are used, they are, in a preferred embodiment, configured as perforated plates having openings having the shape of a truncated cone. Here, the opening diameter on the underside, i.e. on the side from which flow occurs, is smaller than the opening diameter on the upper side.

The thickness of the dividing plate is preferably from 0.1 to 20 cm, more preferably from 1 to 15 cm and particularly preferably from 3 to 10 cm.

The opening diameter on the underside of the perforated plate is, in a preferred embodiment, smaller than the mean gas bubble diameter. The opening diameter on the underside is preferably in the range from 0.5 to 10 cm, more preferably in the range from 0.7 to 8 cm and particularly preferably in the range from 1 to 5 cm. The opening diameter on the upper side is preferably in the range from 0.5 to 30 cm, more preferably in the range from 2 to 20 cm and particularly preferably in the range from 5 to 15 cm. The upper hole diameter is, in a preferred embodiment, selected so that it is greater than the mean gas bubble diameter.

The opening angle, i.e. the angle between the side wall of the opening and the central axis of the opening, is, in a preferred embodiment, selected so that it is greater than the expansion angle of the gas bubbles, so that the fluidized granular material can flow along the lateral surfaces in the openings in a direction counter to the gas flow. For this to be possible and for no stationary bed to be formed on the lateral surfaces of the openings, the opening angle in a preferred embodiment is likewise greater than the angle of repose of the bed of granular material. Here, the angle of repose is the angle at which the granular material in a loose bed just begins to slide down.

The opening angle is preferably in the range from 0 to 60°, more preferably in the range from 10 to 500 and particularly preferably in the range from 20 to 40°.

In a further embodiment, the dividing plate between two temperature zones is made of an insulating material. In this case, it has to be ensured that the material of which the dividing plate is made is stable at the temperatures in the fluidized bed. Thus, ceramic or glass, for example, is suitable in the case of temperatures above 200° C. in the fluidized bed.

Apart from the dividing plate being made of an insulating material, the dividing plate can, in a further embodiment, also have a thermally insulating layer. For this purpose, the dividing plate is preferably configured as a hollow body which is closed off in a gastight and liquid-tight manner from the fluidized bed. The hollow space formed in this way can, for example, be evacuated or comprise air at ambient pressure. The hollow space can also be filled with an insulating material such as glass fibers or rock wool. It is also possible for the dividing plate to be provided with an inlet and an outlet so that a heat exchanger can be passed through the hollow space. In this way, the dividing plate can be utilized as an additional heat exchanger.

In the case of reactions which are carried out in the presence of a catalyst, the fluidized granular material comprises the catalyst. In this case, the individual particles of the granular material can each consist of catalyst material or the catalyst material can be present on their surface. In a preferred embodiment, the catalyst comprises a metal component on an oxidic support. Examples of metal components are ruthenium or copper compounds. As oxidic support, it is possible to use aluminum oxide, in particular γ-aluminum oxide or δ-aluminum oxide, zirconium oxide or titanium oxide or mixtures of these oxides. The oxidic supports are preferably used in powder form having a mean particle diameter of from 30 to 150 μm, more preferably from 40 to 100 μm and in particular from 50 to 80 μm. The fine fraction having a particle size of <20 μm preferably makes up less than 40% by weight, more preferably less than 30% by weight and in particular less than 20% by weight.

When the fluidized-bed reactor is used for the oxidation of hydrogen chloride to chlorine, it is possible to use, for example, the ruthenium-based catalysts known from GB 1,046,313, DE-A 197 48 299 or DE-A 197 34 412. Furthermore, the gold-based catalysts described in DE-A 102 44 996 which comprise from 0.001 to 30% by weight of gold, from 0 to 3% by weight of one or more alkaline earth metals, from 0 to 3% by weight of one or more alkali metals, from 0 to 10% by weight of one or more rare earth metals and from 0 to 10% by weight of one or more other metals selected from the group consisting of ruthenium, palladium, osmium, iridium, silver, copper and rhenium, in each case based on the total weight of the catalyst, on a support are also suitable.

The catalyst is preferably obtained by impregnating a y-aluminum oxide powder with an amount of an aqueous ruthenium chloride hydrate solution corresponding to the water absorption of the support, subsequently drying it at from 100 to 200° C. and finally calcining it at 400° C. in an air atmosphere. The ruthenium content of the catalyst is preferably from 1 to 5% by weight, in particular from 1.5 to 3% by weight.

When a plurality of heat exchangers are used, these can each be provided with their own inlet and outlet and be connected in series or in parallel. When the heat exchangers are connected in parallel, the individual heat exchangers preferably have different heat transfer areas, so that different quantities of heat are taken up or given off by the individual heat exchangers. When the heat exchangers are connected in series, a pump or a throttle valve is preferably located between the heat exchangers so that the pressure of the heat transfer medium in the individual heat exchangers is different. Particularly in the case of boiling or condensing liquids as heat transfer media, a different temperature is in this way established in the heat exchanger as a function of the pressure.

To remove heat from the fluidized bed, it is possible to use, for example, boiling water, since this can take up large quantities of heat at constant temperature. The temperature of the water only alters when all the water has been vaporized. The boiling temperature is dependent on the pressure. The higher the pressure of the boiling water, the higher the boiling temperature. At high temperatures in the fluidized bed, salt melts whose temperature is below the temperature in the fluidized bed are also suitable for the removal of heat. Preference is given to using boiling water.

Further heat transfer media which can be used both for introducing heat and for removing heat from the fluidized bed are, for example, thermal oils or further heat transfer media known to those skilled in the art. The invention is described in more detail below with reference to a drawing.

In the drawing:

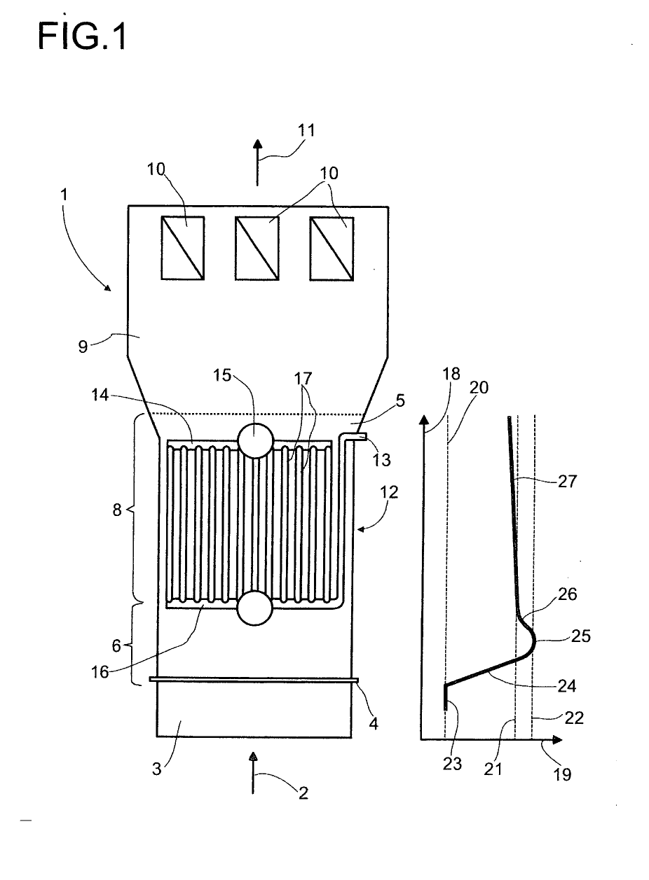

FIG. 1 shows a schematic diagram of a fluidized-bed reactor configured according to the invention together with the temperature profile in the reactor,

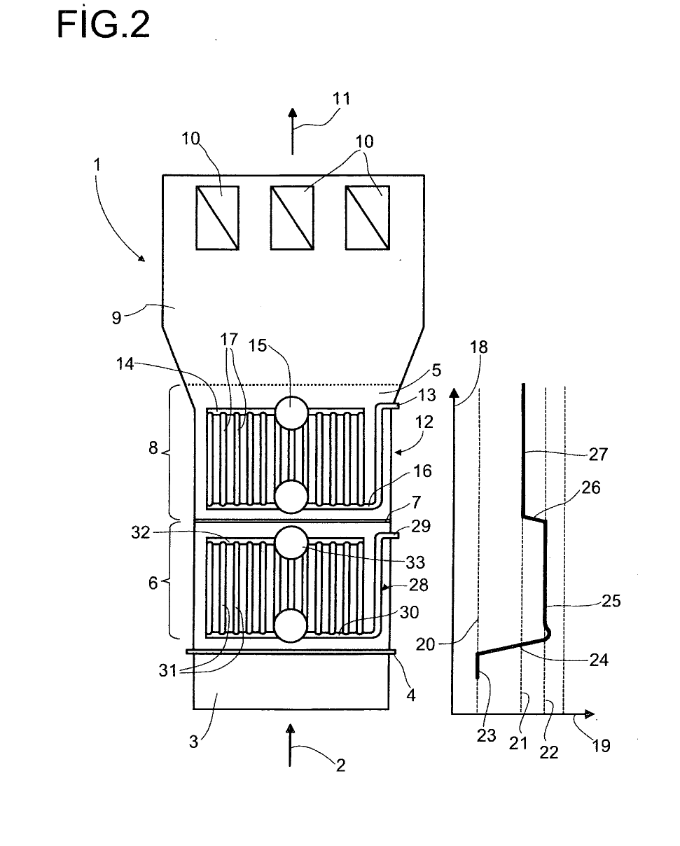

FIG. 2 shows a second embodiment of a fluidized-bed reactor configured according to the invention together with the temperature profile in the reactor,

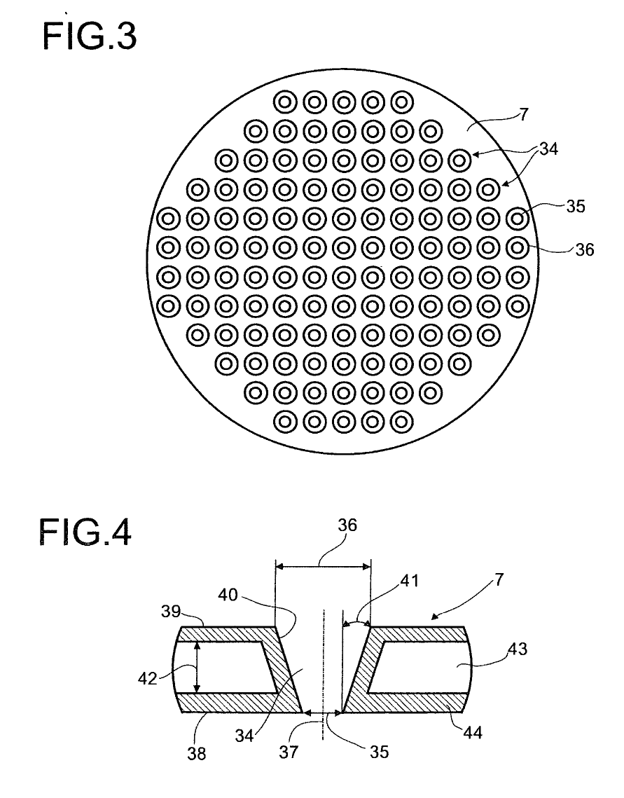

FIG. 3 shows a plan view of a dividing plate configured as a perforated plate having openings having the shape of a truncated cone,

FIG. 4 shows a section through an opening of the dividing plate of FIG. 3.

FIG. 1 shows a schematic diagram of a particularly preferred embodiment of a fluidized-bed reactor configured according to the invention and of the temperature profile in the reactor.

A fluidized-bed reactor 1 comprises a windbox 3, a gas distributor 4, a fluidized bed 5, a disengagement zone 9 and at least one solids precipitator 10. The feed gases are fed into the windbox 3. The introduction of gas is indicated here by the arrow 2. The introduction of gas into the windbox 3 can be, as shown here, from below or else from the side. From the windbox 3, the gas flows through the gas distributor 4 into the fluidized bed 5. The function of the gas distributor 4 is to allow the gas to flow uniformly into the fluidized bed 5, so that good mixing of gas and solid is achieved in the fluidized bed 5. The gas distributor 4 can be a perforated plate or a plate with gas distributor nozzles distributed over it.

The conversion of the feed gases to the product occurs in the fluidized bed 5. Feed gases are, for example, hydrogen chloride and oxygen for the preparation of chlorine.

In the embodiment shown in FIG. 1, the fluidized bed 5 is divided into a first temperature zone 6 and a second temperature zone 8. In this case, no heat exchanger is installed in the first temperature zone 6, so that when exothermic reactions are carried out in the fluidized-bed reactor 1, the temperature in the first temperature zone 6 depends on the heat liberated by the reaction. Owing to the mixing of the granular material of the fluidized bed, the temperature transition from the temperature of the first temperature zone 6 to the temperature of the second temperature zone 8 occurs over a relatively large region of the fluidized bed 5.

A sharper temperature transition can be achieved by arranging a dividing plate 7 (cf. FIG. 2) between the first temperature zone 6 and the second temperature zone 8. The dividing plate is configured so that gas bubbles pass from the first temperature zone 6 through openings in the dividing plate into the second temperature zone 8.

To set a temperature in the second temperature zone 8 which is different from the temperature in the first temperature zone 6, a heat exchanger 12 is installed in the second temperature zone 8. The distance between the gas distributor 4 and the heat exchanger 12 is at least 50 cm in a preferred embodiment.

A heat transfer medium is fed via a heat transfer medium inlet 13 into the heat exchanger 12. The heat transfer medium flows via the heat transfer medium distributor 16 into heat exchanger tubes 17. The heat exchanger tubes 17 open into a vapor manifold 14 via which the heat transfer medium is passed to a heat transfer medium outlet 15 and is taken off from the heat exchanger 12. The quantity of heat to be taken up or given off by the heat exchanger 12 can be set via the number of heat exchanger tubes 17 and the mass flow of the heat transfer medium.

When heat is to be removed from the fluidized bed 5 via the heat exchanger 12, suitable heat transfer media are, for example, boiling water which vaporizes as a result of the uptake of heat, thermal oils or, in the case of high temperatures in the fluidized bed 5, salt melts. The heat transfer medium is in this case at a temperature which is below the temperature in the fluidized bed 5.

The fluidized bed 5 is adjoined by the disengagement zone 9. Separation of gas and solid occurs in the disengagement zone 9. To remove further entrained solid particles from the product gas, at least one solids precipitator 10 is preferably located in the upper region of the disengagement zone 9. In addition to the embodiment shown in FIG. 1, in which at least one solids precipitator 10 is located within the fluidized-bed reactor 1, the solids precipitator or precipitators 10 can also be located outside the fluidized-bed reactor 1. The arrow 11 indicates the discharge of product following the solids precipitator or precipitators 10.

Suitable solids precipitators 10 are, for example, cyclones or candle filters.

FIG. 1 also shows the temperature profile in the fluidized-bed reactor 1. Here the axis 18 shows the height along the fluidized-bed reactor 1 and the axis 19 indicates the temperature. The broken lines in the graph indicate a first temperature level 20, a second temperature level 21 and a third temperature level 22. The temperature of the first temperature level 20 is lower than the temperature of the second temperature level 21 whose temperature is in turn below that of the third temperature level 22. The feed gases are fed into the windbox 3 of the fluidized-bed reactor 1 at the feed temperature 23. The reaction commences in the fluidized bed 5. Heat is liberated in this reaction. For this reason, the temperature rises in the region of the first temperature zone 6 during a warm-up phase 24 until it reaches the third temperature level 22. After the third temperature level 22 has been reached, a constant temperature 25 is established within the first temperature zone 6 due to the mixing of the fluidized bed 5.

In the preferred process variant shown in FIG. 1, heat is removed via the heat exchanger 12. For this reason, cooling occurs in the second temperature zone 8. Owing to the thorough mixing of the fluidized bed 5, a substantially constant temperature 27 also prevails in the second temperature zone 8. The temperature 27 is at the second temperature level 21. However, it is also possible and generally advantageous for the temperature to decrease somewhat in the flow direction in the region of the second temperature zone 8. This is the case particularly when the reaction rate decreases sharply with increasing conversion in the upper part close to the surface of the fluidized bed 5. The transition from the temperature 25 in the first temperature zone 5 to the temperature 27 in the second temperature zone 8 occurs via a cooling phase 26.

FIG. 2 shows a second embodiment of a fluidized-bed reactor with a schematic depiction of the temperature profile.

The fluidized-bed reactor 1 shown in FIG. 2 differs from the embodiment shown in FIG. 1 in that a further heat exchanger 28 is installed in the first temperature zone 6. The construction and mode of operation of the second heat exchanger 28 corresponds to that of the heat exchanger 12. A heat transfer medium is fed into the second heat exchanger 28 via a heat transfer medium inlet 29. The heat transfer medium flows through heat transfer medium distributors 30 into heat exchanger tubes 31. The heat exchanger tubes 31 open into a vapor manifold 32 via which the heat transfer medium is passed to a heat transfer medium outlet 33 and is taken off from the second heat exchanger 28.

Different temperatures in the first temperature zone 6 and the second temperature zone 8 can be achieved by means of different heat-transfer areas of the heat exchangers 12, 28. Thus, for example, the second heat exchanger 28 can have fewer heat exchanger tubes 31 than the first heat exchanger 12. This leads to the heat-transfer area of the second heat exchanger 28 being very much smaller than the heat-transfer area of the first heat exchanger 12. As a result, less heat can be removed via the second heat exchanger 28 than via the heat exchanger 12. This results in a higher temperature 25 in the first temperature zone 6 of the fluidized bed 5.

The use of the second heat exchanger 28 makes the region of the warm-up phase 28 or the cooling phase 26 smaller. The transition from one temperature level to the other is therefore quicker.

The first temperature zone 6 and the second temperature zone 8 are separated by a dividing plate 7. The dividing plate 7 is configured so that the gas bubbles pass through openings in the dividing plate 7 into the second temperature zone 8. The dividing plate 7 ensures that only a small proportion of the granular material of the fluidized bed is entrained in the ascending gas. This avoids complete mixing of the granular material of the first temperature zone 6 and the second temperature 8 of the fluidized bed. The dividing plate 7 thus allows a sharper separation between the first temperature zone and the second temperature zone 8.

In a preferred embodiment, the dividing plate 7 has an insulating action. For this purpose, it is either made of an insulating material or has a thermally insulating layer.

A less sharp transition between the first temperature zone 7 and the second temperature zone 8 is achieved when the dividing plate 7 between the first temperature zone 6 and the second temperature zone 8 is omitted. In this case, a slower transition from the temperature 25 of the first temperature zone 6 to the temperature 27 of the second temperature zone 8 results from the mixing of the fluidized granular material between the first temperature zone 6 and the second temperature zone 8.

In addition to the embodiments having two temperature zones 6, 8 shown in FIGS. 1 and 2, it is also possible to divide the fluidized bed 5 into more than two temperature zones. In this case, it is possible, for example, for temperature zones with heat exchangers to alternate with temperature zones without heat exchangers. It is also possible to provide each temperature zone with a heat exchanger. Dividing plates can be installed between the individual temperature zones. If a slower transition between the temperatures of the individual temperature zones is desired, no dividing plates 7 are located between the temperature zones.

FIG. 3 shows a plan view of an embodiment of a dividing plate 7 having openings 34 which have the shape of a truncated cone. The openings 34 can be arranged in any way known to those skilled in the art. Thus, for example, the openings 34 can not only be arranged along mutually perpendicular axes as shown here but the openings 34 can also be offset relative to one another.

A section through an opening 34 having the shape of a truncated cone is shown in FIG. 4. The opening 34 has a first opening diameter 35 on the underside 38 of the dividing plate 7 and this opening diameter 35 is smaller than the second opening diameter 36 of the opening 34 on the upper side 39 of the dividing plate 7. In the case of the opening 34 having the shape of a truncated cone as shown here, the opening diameter increases uniformly from the underside 34 to the upper side 39 of the dividing plate 7. The side wall 40 of the opening 34 is inclined at an angle 41 to the axis 37 of the opening. The angle 41 is preferably in the range from 0 to 60°, more preferably in the range from 10 to 50° and in particular in the range from 20 to 40°.

The first opening diameter 35 is selected so that it is smaller than the mean gas bubble diameter of the gas bubbles in the fluidized bed 5. The first opening diameter 35 is preferably in the range from 0.5 to 10 cm, more preferably from 0.7 to 8 cm and in particular in the range from 1 to 5 cm. On the other hand, the second opening diameter 36 is selected so that it is greater than the mean gas bubble diameter of the gas bubbles in the fluidized bed 5. The second opening diameter 36 is preferably in the range from 0.5 to 30 cm, more preferably in the range from 2 to 20 cm and in particular in the range from 5 to 15 cm. In the embodiment shown in FIG. 4, the dividing plate 7 is configured as a hollow body. Here, the interior space is bounded by respectively the upper side 39, the underside 38 of the dividing plate 7 and the side wall 40 of the openings 34. The hollow space 43 formed in this way can, for example, be evacuated or be filled with air under ambient pressure. The hollow space 43 can comprise any further thermally insulating materials known to those skilled in the art. Examples of suitable materials are glass wool or mineral wool.

The height of the hollow space 43 is denoted by the reference numeral 42. The height 42 is preferably in the range from 0.1 to 20 cm, more preferably in the range from 1 to 15 cm and in particular in the range from 3 to 10 cm. The material for the wall 44 of the dividing plate 7 is preferably selected so that it is chemically stable toward the feed gases and product gases. The thickness of the wall 44 is preferably in the range from 1 to 50 mm, more preferably in the range from 2 to 30 mm and in particular in the range from 5 to 20 mm.

Apart from the variants having an insulating layer, as shown in FIG. 4, the dividing plate 7 can also be made entirely of an insulating material. Suitable materials are, for example, glass or ceramic.

All plates known to those skilled in the art which allow passage of gas and granular solids are suitable as dividing plates 7. Thus, in addition to the perforated plates shown in FIGS. 3 and 4, further particularly useful plates are, for example, screen plates.

### List of Reference Numerals

1 Fluidized-bed reactor
2 Introduction of feed
3 Windbox
4 Gas distributor
5 Fluidized bed
6 First temperature zone
7 Dividing plate
8 Second temperature zone
9 Disengagement zone
10 Solids precipitator
11 Product discharge
12 Heat exchanger
13 Heat transfer medium inlet
14 Vapor manifold
15 Heat transfer medium outlet
16 Heat transfer medium distributor
17 Heat exchanger tubes
18 Height
19 Temperature
20 First temperature level
21 Second temperature level
23 Third temperature level
24 Warm-up phase
25 Temperature in the first temperature zone 5
26 Cooling phase
27 Temperature in the second temperature zone 7
28 Second heat exchanger
29 Heat transfer medium inlet
30 Heat transfer medium distributor
31 Heat exchanger tubes
32 Vapor manifold
33 Heat transfer medium outlet
34 Openings
35 First opening diameter
36 Second opening diameter
37 Axis of opening
38 Underside
38 Upper side
40 Side wall of the opening 34
41 Opening angle
42 Height of the hollow space 43
43 Hollow space
44 Wall

1-9. (canceled)

10: A process for carrying out exothermic chemical equilibrium reactions in a fluidized-bed reactor, wherein there is a temperature distribution along the flow direction in the fluidized bed of the fluidized-bed reactor and the temperature difference between the lowest temperature and the highest temperature is at least 10 K and wherein the temperature within the fluidized bed decreases from an absolute temperature maximum along the flow direction to the surface of the fluidized bed.

11: The process according to claim 1, wherein the temperature within the fluidized bed decreases from an absolute temperature maximum in the fluidized bed along the flow direction to the surface of the fluidized bed and to the gas distributor.

12: The process according to claim 1, wherein the distance between the absolute temperature maximum and the gas distributor is smaller than the distance between the absolute temperature maximum and the surface of the fluidized bed.

13: The process according to claim 1, wherein the temperature of the reaction gases fed to the fluidized-bed reactor is below the lowest temperature occurring in the fluidized bed.

14: The process according to claim 1, wherein the temperature distribution is produced by heat transfer to at least one heat exchanger within the fluidized bed.

15: The process according to claim 1, wherein the chemical reaction is the preparation of chlorine from hydrogen chloride and oxygen.

16: The process according to claim 1, wherein the fluidized bed comprises a catalyst which comprises a metal component on an oxidic support.

17: The process according to claim 7, wherein the catalyst comprises a ruthenium compound.

18: A fluidized-bed reactor for carrying out the process according to claim 1 in a fluidized bed into which reaction gases are fed via a gas distributor, wherein at least one heat exchanger is located in the fluidized bed to control the temperature distribution within the fluidized bed and wherein the distance between the gas distributor and the nearest heat exchanger is at least 50 cm.
